(19) United States
(12) Patent Application Publication
(10) Pub. No.: US 2012/0039103 A1
(43) Pub. Date: Feb. 16, 2012

(54) SINGLE-STAGE AC/DC CONVERTER

(75) Inventors: Ming Xu, Nanjing (CN); Julu Sun, Nanjing (CN); Chao Sun, Nanjing (CN)

(73) Assignees: FSP TECHNOLOGY INC., Taoyuan County (TW); FSP-POWERLAND TECHNOLOGY INC., Nanjing (CN)

(21) Appl. No.: 13/207,435

(22) Filed: Aug. 11, 2011

(30) Foreign Application Priority Data
Aug. 13, 2010 (CN) 201010253519.2

(51) Int. Cl. H02M 7/06

(52) U.S. Cl. 363/126

(57) ABSTRACT

A single-stage AC/DC converter is provided, and which includes a power-frequency follow-current circuit, an isolated transmission circuit (ITC), a high-frequency chopper modulation circuit (HFCMC), a power-frequency and high-frequency AC rectifying-circuit and a filter-circuit. The input of the ITC is connected to the output of an external power-frequency power source, the current-modulating side of the ITC is connected to the input of the HFCMC, the output of the ITC is connected to the input of the power-frequency and high-frequency AC rectifying-circuit, the output of the HFCMC is connected to the input of the external power-frequency power source through the power-frequency follow-current connected in series with the HFCMC , and the output of the power-frequency and high-frequency AC rectifying circuit is connected to a load through the filter circuit connected in series with the power-frequency and high-frequency AC rectifying-circuit. The invention simplifies the rectifier part with higher transformation efficiency.

### CROSS-REFERENCE TO RELATED APPLICATION

This application claims the priority benefit of China application serial no. 201010253519.2, filed on Aug. 13, 2010. The entirety of the above-mentioned patent application is hereby incorporated by reference herein and made a part of this specification.

### BACKGROUND OF THE INVENTION

1. Field of the Invention

The invention relates to an isolated transmission field of AC/DC power, more particularly, to a single-stage AC/DC converter.

2. Description of Related Art

After reviewing the current power converting architecture of AC/DC power sources, it can be seen that there are duplicate power converting parts in a whole power-flow process. No matter in a single-stage PFC AC/DC converter or two-stage (PFC+DC/DC) AC/DC converter, at the front-most end thereof, always an AC/DC rectifier part with power frequency is employed. However at the secondary side of a transformer, an AC/DC rectifier part with high-frequency is still employed to convert the transmitted high-frequency electrical energy produced with inverting at the primary side into DC energy. As shown in FIG. 1 which is a schematic diagram of a conventional power conversion topology, at the front-most end, there is an AC/DC rectifier part (R1). And at the secondary side of a transformer T, an AC/DC rectifier part (R2) is still employed. Thus, there are two rectifying operations during a whole power transmission process, which would additionally increase the transformation loss of the circuit and reduce the power converting efficiency.

### SUMMARY OF THE INVENTION

Accordingly, aiming the technical fault in the prior art, the invention is directed to simplify rectifier parts into one part to obtain a higher transformation efficiency and provide a single-stage AC/DC converter.

In order to realize the above-mentioned object, the invention adopts a following technical scheme.

The invention provides a single-stage AC/DC converter, which includes a power frequency follow current circuit, an isolated transmission circuit, a high-frequency chopper modulation circuit, a power frequency and high-frequency AC rectifying circuit and a filter circuit, in which the input of the isolated transmission circuit is connected to the output of an external power frequency power source, the current-modulating side of the isolated transmission circuit is connected to the input of the high-frequency chopper modulation circuit, the output of the isolated transmission circuit is connected to the input of the power frequency and high-frequency AC rectifying circuit, the output of the high-frequency chopper modulation circuit is connected to the input of the external power frequency power source through the power frequency follow current circuit connected in series with the high-frequency chopper modulation circuit, and the output of the power frequency and high-frequency AC rectifying circuit is connected to a load through the filter circuit connected in series with the power frequency and high-frequency AC rectifying circuit.

In one embodiment of the invention, the isolated transmission circuit includes two half-wave isolated transmission sub-circuits, and each of the half-wave isolated transmission sub-circuits includes an input inductor and an isolated transformer correspondingly disposed therein.

In one embodiment of the invention, both the input inductors respectively work in a duration of positive half-wave at the power frequency power source and a duration of negative half-wave at the power frequency power source.

In one embodiment of the invention, the high-frequency chopper modulation circuit includes a first to a fourth transistors to be formed as a bridge switching circuit, and the first to the fourth transistors are modulated by a means of pulse width modulation (PWM), so as to control currents respectively flowing through the input inductors.

In one embodiment of the invention, the high-frequency chopper modulation circuit is used for performing a high-frequency chopper modulation on a power frequency input voltage from the output of the power frequency power source by a means of switching operations of the bridge switching circuit, so as to transmit a modulated power frequency and high-frequency AC voltage to secondary sides of the isolated transformers.

In one embodiment of the invention, the power frequency and high-frequency AC rectifying circuit includes two rectifier diodes respectively connected to the secondary sides of the isolated transformers for rectifying the power frequency and high-frequency AC voltage, so as to provide a DC output voltage to the load through the filter circuit.

In one embodiment of the invention, two of the first to the fourth transistors are operated respectively complementarily to the other two of the first to the fourth transistors, so as to realize a function of active-clamping.

In one embodiment of the invention, the single-stage AC/DC converter further includes a clamp capacitor connected in parallel with both terminals of the high-frequency chopper modulation circuit for low-frequency energy-storing and clamping the first to the fourth transistors.

In the invention, a high-frequency chopper modulation is performed on a power frequency input voltage by means of switching operations of a bridge switching circuit, so that the modulated power frequency AC voltage can be isolated transmitted to the secondary sides through small high-frequency isolated transformers. In addition, the voltage amplitude can be adjusted by means of the transformer ratio. In this way, a power frequency and high-frequency AC voltage signal can be rectified by using the rectifier diode(s) at the secondary sides of the isolated transformers.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional power conversion topology.

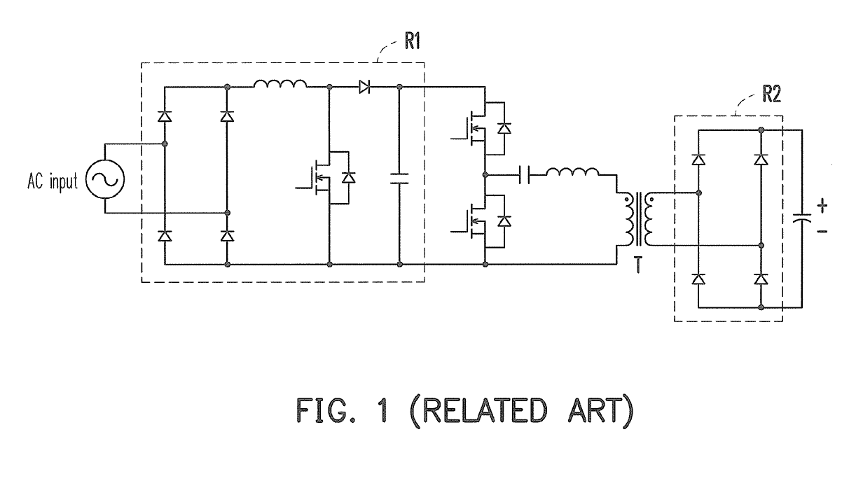

FIG. 2 is a schematic diagram of a circuit principle of the invention.

### DESCRIPTION OF THE EMBODIMENTS

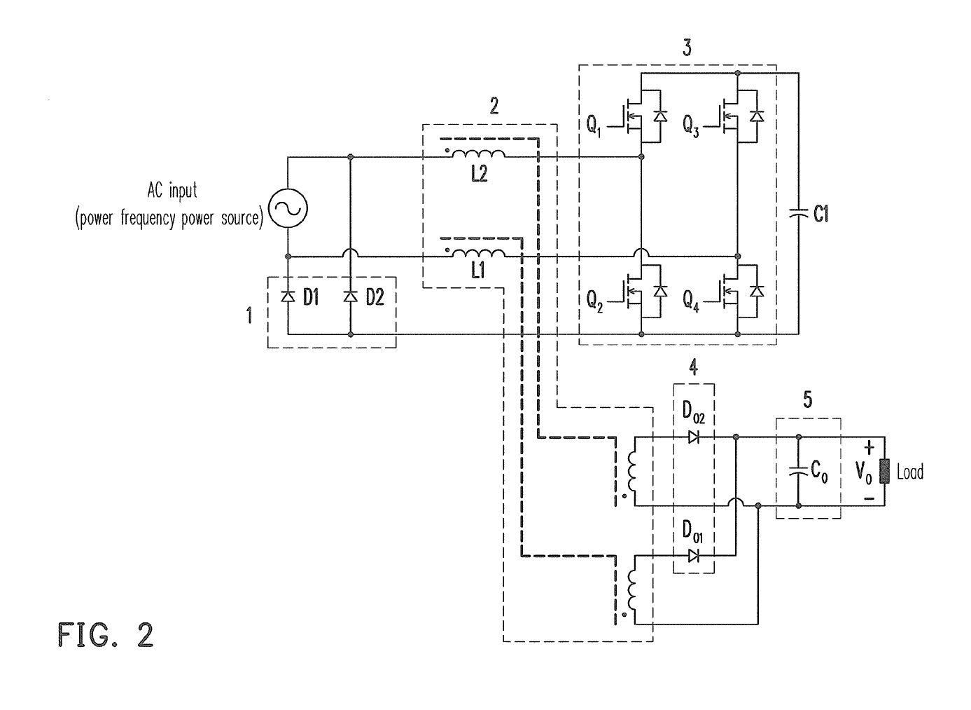

Referring to FIG. 2, a single-stage AC/DC converter of the invention includes a power frequency follow current circuit (1) consisted of two diodes D1 and D2, an isolated transmission circuit (2), a high-frequency chopper modulation circuit (3), a power frequency and high-frequency AC rectifying circuit (4) consisted of two rectifier diodes D₀1 and D₀2 (also may use the diode-connected MOSFETs to replace the rectifier diodes D₀1 and D₀2), and a filter circuit (5) consisted of one capacitor C₀, in which the input of the isolated transmission circuit (2) is connected to the output of an external power frequency power source (i.e. AC input), the current-modulating side of the isolated transmission circuit (2) is connected to the input of the high-frequency chopper modulation circuit (3), the output of the isolated transmission circuit (2) is connected to the input of the power frequency and high-frequency AC rectifying circuit (4), the output of the high-frequency chopper modulation circuit (3) is connected to the input of the external power frequency power source through the power frequency follow current circuit (1) connected in series with the high-frequency chopper modulation circuit (3), and the output of the power frequency and high-frequency AC rectifying circuit (4) is connected to a load through the filter circuit (5) connected in series with the power frequency and high-frequency AC rectifying circuit (4), and provides a DC output voltage V₀ to the load through the filter circuit (5).

As shown in FIG. 2, the isolated transmission circuit (2) includes two half-wave isolated transmission sub-circuits, and each of the half-wave isolated transmission sub-circuits includes an input inductor (L1/L2) and an isolated transformer correspondingly disposed therein.

The high-frequency chopper modulation circuit (3) includes four transistors Q₁ to Q₄, and the transistors Q₁ to Q₄ would form a bridge switching circuit. In addition, both terminals of the high-frequency chopper modulation circuit 3 are connected in parallel to a clamp capacitor C1, the clamp capacitor is used for low-frequency energy-storing and clamping the transistors Q1 to Q4.

The operation mode of the single-stage AC/DC converter is that: the input inductors L2 and L1 respectively work in a duration of positive half-wave at the power frequency power source and a duration of negative half-wave at the power frequency power source. The transistors Q2 and Q4 are respectively modulated by a means of pulse-width-modulation (PWM), so as to control the currents of the input inductors (i.e. currents respectively flowing through the input inductors L1 and L2), and make sure the currents have sine waveform and required amplitudes. The transistors Q1 and Q3 are operated respectively complementarily to the transistors Q2 and Q4 so as to realize the function of active-clamping. In other words, the transistors Q1 and Q2 are turned on complementarily, and the transistors Q3 and Q4 are turned on complementarily.

From the above, a high-frequency chopper modulation is performed on a power frequency input voltage by means of switching operations of a bridge switching circuit, so that the modulated power frequency AC voltage can be isolated transmitted to the secondary sides through small high-frequency isolated transformers. In addition, the voltage amplitude can be adjusted by means of the transformer ratio. In this way, a power frequency and high-frequency AC voltage signal can be rectified by using the rectifier diode(s) (i.e. D₀1 and D₀2) at the secondary sides of the isolated transformers. Under the circuit configuration of the single-stage AC/DC converter as shown in FIG. 2, the invention is directed to simplify rectifier parts into one part to obtain higher transformation efficiency.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A single-stage AC/DC converter, comprising:
a power frequency follow current circuit;
an isolated transmission circuit;
a high-frequency chopper modulation circuit;
a power frequency and high-frequency AC rectifying circuit; and
a filter circuit,
wherein an input of the isolated transmission circuit is connected to an output of an external power frequency power source, a current-modulating side of the isolated transmission circuit is connected to an input of the high-frequency chopper modulation circuit, an output of the isolated transmission circuit is connected to an input of the power frequency and high-frequency AC rectifying circuit, an output of the high-frequency chopper modulation circuit is connected to an input of the external power frequency power source through the power frequency follow current circuit connected in series with the high-frequency chopper modulation circuit, and an output of the power frequency and high-frequency AC rectifying circuit is connected to a load through the filter circuit connected in series with the power frequency and high-frequency AC rectifying circuit.

2. The single-stage AC/DC converter as claimed in claim 1, wherein the isolated transmission circuit comprises two half-wave isolated transmission sub-circuits, and each of the half-wave isolated transmission sub-circuits comprises an input inductor and an isolated transformer correspondingly disposed therein.

3. The single-stage AC/DC converter as claimed in claim 2, wherein both the input inductors respectively work in a duration of positive half-wave at the power frequency power source and a duration of negative half-wave at the power frequency power source.

4. The single-stage AC/DC converter as claimed in claim 3, wherein the high-frequency chopper modulation circuit comprises a first to a fourth transistors to be formed as a bridge switching circuit, and the first to the fourth transistors are modulated by a means of pulse width modulation (PWM), so as to control currents respectively flowing through the input inductors.

5. The single-stage AC/DC converter as claimed in claim 4, wherein the high-frequency chopper modulation circuit is used for performing a high-frequency chopper modulation on a power frequency input voltage from the output of the power frequency power source by a means of switching operations of the bridge switching circuit, so as to transmit a modulated power frequency and high-frequency AC voltage to secondary sides of the isolated transformers.

6. The single-stage AC/DC converter as claimed in claim 5, wherein the power frequency and high-frequency AC rectifying circuit comprises two rectifier diodes respectively connected to the secondary sides of the isolated transformers for rectifying the power frequency and high-frequency AC voltage, so as to provide a DC output voltage to the load through the filter circuit.

7. The single-stage AC/DC converter as clamed in claim 4, wherein two of the first to the fourth transistors are operated respectively complementarily to the other two of the first to the fourth transistors, so as to realize a function of active-clamping.

8. The single-stage AC/DC converter as claimed in claim 3, further comprises:
a clamp capacitor connected in parallel with both terminals of the high-frequency chopper modulation circuit, for low-frequency energy-storing and clamping the first to the fourth transistors.
